(19) United States
(12) Patent Application Publication
(10) Pub. No.: US 2025/0077149 A1
(43) Pub. Date: Mar. 6, 2025

(54) INFORMATION PROCESSING METHOD, INFORMATION PROCESSING APPARATUS, AND STORAGE MEDIUM

(71) Applicant: CANON KABUSHIKI KAISHA, Tokyo (JP)

(72) Inventor: Tetsuhide Takasaki, Tokyo (JP)

(21) Appl. No.: 18/816,046

(22) Filed: Aug. 27, 2024

(30) Foreign Application Priority Data
Aug. 30, 2023 (JP) 2023-139884

(51) Int. Cl. G06F 3/12

(52) U.S. Cl. CPC G06F 3/127; G06F 3/1205

(57) ABSTRACT

Provided is an information processing method including: obtaining print data including first print setting information indicating setting information on printing and second print setting information set for each of a plurality of hot folders; and displaying the plurality of hot folders based on the first print setting information and the second print setting information.

### BACKGROUND OF THE INVENTION

### Field of the Invention

The present disclosure relates to a technique of displaying hot folders.

### Description of the Related Art

In the commercial printing field where a provider receives an order for producing printed products from a client, produces printed products as desired by the client, delivers them, and receives a reward from the client, hot folders are widely used as a method for submitting print data to a printing apparatus. Hot folders are classified based on clients, types of printed products, and print setting conditions such as a base material. Then, an enormous number of hot folders thus classified are registered in a printing apparatus. Thus, in the commercial printing field, a hot folder suitable for print data needs to be selected from the enormous number of hot folders registered in the printing apparatus.

Japanese Patent Laid-Open No. 2014-2688 (Literature 1) discloses a method which, in a case where print data is submitted to a hot folder through operation of a GUI, prevents erroneous submission of an unprintable job to the icon of a folder linked with a printing apparatus disposed on an UI screen.

The method in Literature 1, however, presents a challenge in that a hot folder suitable for print data cannot be selected efficiently.

### SUMMARY OF THE INVENTION

An information processing method according to an aspect of the present disclosure includes: obtaining print data including first print setting information indicating setting information on printing and second print setting information set for each of a plurality of hot folders; and displaying the plurality of hot folders based on the first print setting information and the second print setting information.

Further features of the present invention will become apparent from the following description of exemplary embodiments with reference to the attached drawings.

### BRIEF DESCRIPTION OF THE DRAWINGS

FIG. 1 is a block diagram showing an example hardware configuration of a printing system;

FIG. 2 is a block diagram showing an example hardware configuration of a printing apparatus;

FIG. 3 is a block diagram showing an example configuration of a hot folder service program;

FIG. 4 is a diagram showing an example of a hot folder setting screen;

FIG. 5 is a diagram showing an example of a hot folder setting information file;

FIG. 6 is a diagram showing an example of a print job ticket;

FIG. 7 is a diagram showing an example of a printer information file;

FIG. 8 is a diagram showing an example of a label printing application screen;

FIG. 9 is a diagram showing an example of a printer information folder setting screen;

FIG. 10 is a diagram showing an example of a hot folder menu list;

FIG. 11 is a diagram showing an example of a hot folder list registration screen;

FIG. 12 is a diagram showing an example of a hot folder list deletion screen;

FIG. 13 is a flowchart showing an example of hot folder list update processing;

FIG. 14 is a diagram showing an example of hot folder setting information files;

FIG. 15 is a diagram showing an example of a hot folder priority order table;

FIG. 16 is a diagram showing an example of a hot folder menu list;

FIG. 17 is a flowchart showing an example of hot folder list update processing;

FIG. 18 is a diagram showing an example of hot folder setting information files;

FIG. 19 is a diagram showing an example of a hot folder priority order table;

FIG. 20 is a diagram showing an example of a hot folder menu list;

FIG. 21 is a diagram showing an example of a priority item setting screen;

FIG. 22 is a flowchart showing an example of hot folder list update processing;

FIG. 23 is a diagram showing an example of hot folder setting information files;

FIG. 24 is a diagram showing an example of a hot folder priority order table;

FIG. 25 is a diagram showing an example of a hot folder menu list;

FIG. 26 is a flowchart showing an example of printability determination processing; and

FIG. 27 is a diagram showing an example of a warning message screen.

### DESCRIPTION OF THE EMBODIMENTS

Preferred embodiments of the present disclosure are described in detail below with reference to the drawings attached hereto. Note that the embodiments below do not limit the matters of the present disclosure and not all the combinations of features described in the embodiments below are necessarily essential as solutions provided by the present disclosure. Note that the same constituents are denoted by the same reference number to omit a description.

### First Embodiment

### <Hardware Configuration of a Printing System>

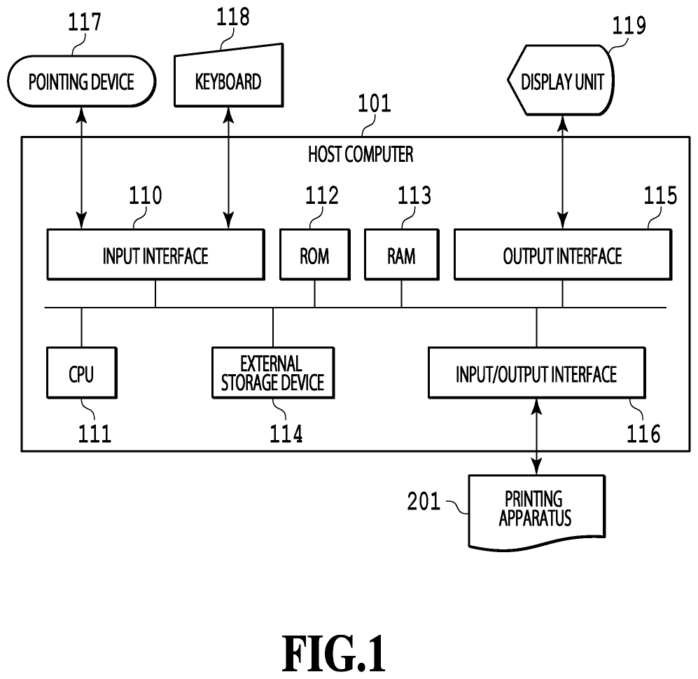

In the present embodiment, an example of a printing system used in a printing process in commercial printing is described. FIG. 1 is a block diagram showing an example hardware configuration of the printing system. The configuration of a host computer 101 is described with reference to FIG. 1. The host computer 101 is an example of an information processing apparatus and has an input interface 110, a central processing unit (CPU) 111, and a read-only memory (ROM) 112. The host computer 101 has a random-access memory (RAM) 113, an external storage device 114, an output interface 115, and an input/output interface 116. Also, an input device such as a pointing device 117 and a keyboard 118 are connected to the input interface 110. Also, a display device such as a display unit 119 is connected to the output interface 115.

The host computer 101 receives input of control data from the pointing device 117 and/or the keyboard 118 via the input interface 110. The ROM 112 is a non-volatile storage medium and stores programs executed by the CPU 111 such as control programs and an initialization program and fixed data such as the operating system (OS). The external storage device 114 stores various externally obtained programs such as application programs and other various kinds of data. The RAM 113 is main storage memory for the CPU 111 and is used as a temporary storage region into which to load the programs stored in the ROM 112 and the external storage device 114. The CPU 111 is a central processing unit and executes various kinds of control by loading the programs stored in the ROM 112 and the external storage device 114 into the RAM 113 and reading them. The host computer 101 displays image data on the display unit 119 via the output interface 115. A printing apparatus 201 is connected to the host computer 101 via an input/output interface 116. The host computer 101 transmits a print job file to be described later or other data such as setting information related to printing to the printing apparatus 201 via the input/output interface 116. Note that a plurality of the printing apparatuses 201 may be connected to the host computer 101. Although the host computer 101 is configured separately from the printing apparatus 201 in the example described in the present embodiment, the present disclosure is not limited to this. For example, the host computer 101 and the printing apparatus 201 may be configured as a single information processing apparatus. Also, the host computer 101 may be a desktop personal computer, a smartphone, or a laptop personal computer.

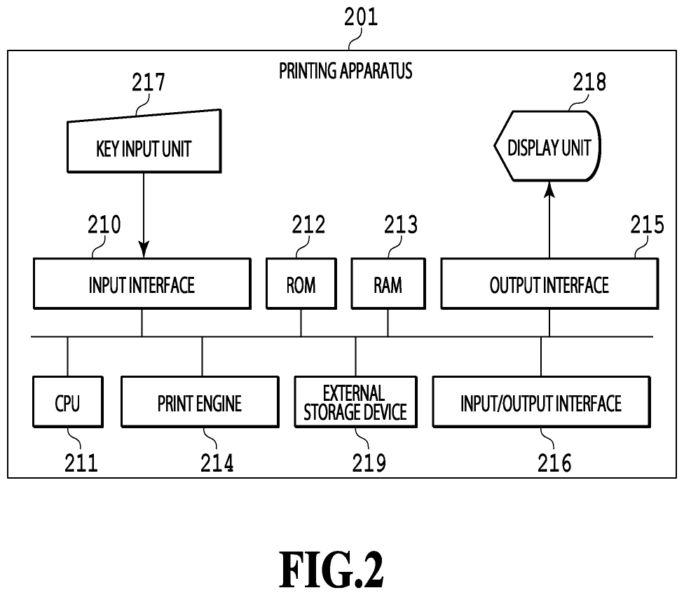

FIG. 2 is a block diagram showing an example hardware configuration of the printing apparatus 201. The configuration of the printing apparatus 201 is described with reference to FIG. 2. The printing apparatus 201 has an input interface 210, a CPU 211, a ROM 212, and a RAM 213. The printing apparatus 201 has a print engine 214, an output interface 215, an input/output interface 216, a key input unit 217, a display unit 218, and an external storage device 219. The key input unit 217 includes numerical input keys, a mode setting key, an enter key, a cancel key, and the like. The printing apparatus 201 receives user operations from the key input unit 217 via the input interface 210. The display unit 218 is configured of a liquid crystal display (LCD) or the like and displays details on print data received, the status of the printing apparatus, and the like as image data via the output interface 215. The CPU 211 is a system controller, and the CPU 211 performs overall control of the printing apparatus 201 and executes a hot folder service program to be described later. The ROM 212 stores programs executed by the CPU 211 such as control programs and the hot folder service program and fixed data such as data tables. The external storage device 219 stores a plurality of hot folders registered by user operations and also stores a print job and a job ticket received from the host computer 101. The RAM 213 is used by the CPU 211 as work memory and is also used as a temporary storage buffer for print jobs.

The print engine 214 forms an image on a printing medium such as paper using a printing material such as ink based on a print job file and, as needed, a print job ticket received from the host computer 101 and outputs a printed result. A print job file is a file outputted in the event where print data set by a label print application to be described later is submitted to a hot file. A print job ticket is a file outputted in a case where a hot folder to which to submit print data is a flexible hot folder. A flexible hot folder is a hot folder such that the set value of at least one of setting items of the hold folder can be specified using a print job ticket. More specifically, the print engine 214 outputs a printed result based on a print job file in which print information is set and, as needed, a print job ticket specifying a set value. In the present embodiment, Portable Document Format (PDF) is used as the format of print job files. Also, Extensible Markup Language (XML) is used as the format of print job tickets. However, the file formats of print job files and print job tickets are not limited to these. Connection between the input/output interface 116 of the host computer 101 and the input/output interface 216 of the printing apparatus 201 enables the host computer 101 and the printing apparatus 201 to communicate with each other. The mode of connection between them may be, but not limited to, network connection. Although the printing apparatus 201 is an inkjet printer that performs printing by ejecting ink to a paper surface in the example described in the present embodiment, other methods (e.g., electrophotography) may be used to execute the printing.

### <Configuration of the Hot Folder Service Program>

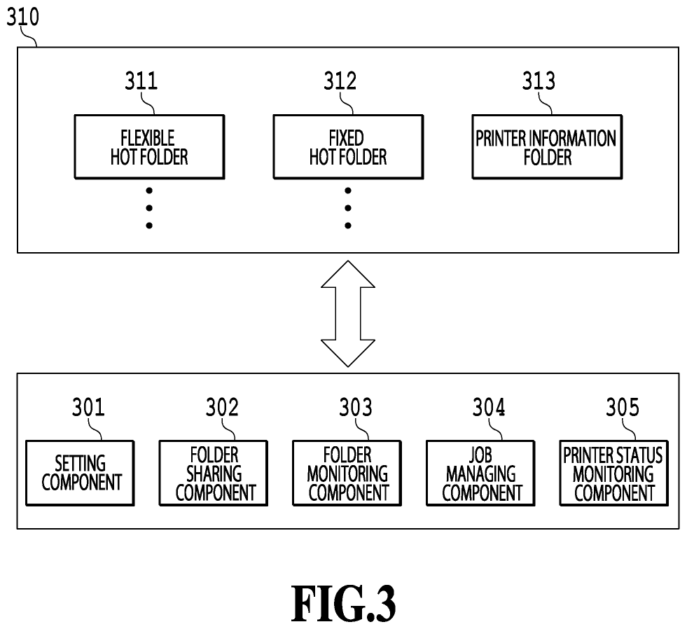

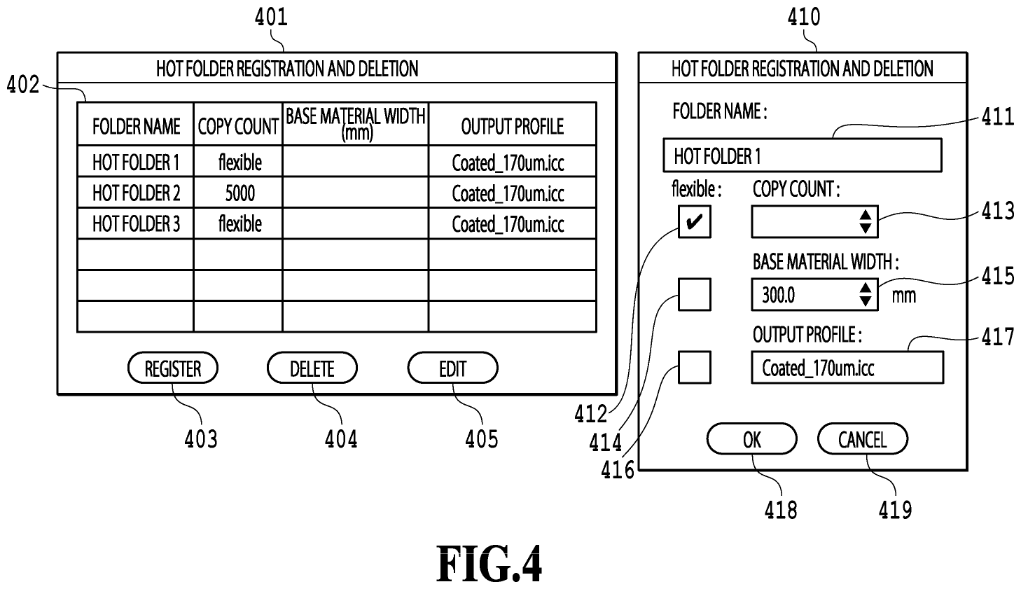

FIG. 3 is a diagram showing an example configuration of the hot folder service program of the printing apparatus 201. Components to be described later operate on the printing apparatus 201 as the CPU 211 of the printing apparatus 201 reads and executes programs. A hot folder service program 300 has a setting component 301, a folder sharing component 302, a folder monitoring component 303, a job managing component 304, and a printer status monitoring component 305. The setting component 301 performs setting of a hot folder provided by the printing apparatus 201. Upon being instructed to set a hot folder, the setting component 301 displays a hot folder setting screen 401 shown in FIG. 4 on the display unit 218.

FIG. 4 is a diagram showing an example of the hot folder setting screen 401. Setting of a hot folder is described with reference to FIG. 4. The hot folder setting screen 401 has a hot folder list 402, a hot folder registration button 403, a hot folder deletion button 404, and a hot folder edit button 405. On the hot folder list 402, hot folders registered in the hot folder service program 300 are displayed in list form. Pressing the hot folder deletion button 404 with a hot folder displayed in the hot folder list 402 being selected deletes the selected hot folder. Then, the hot folder is un-shared and excluded from hot folders to be monitored. Pressing the hot folder registration button 403 with no hot folder in the hot folder list 402 being selected displays a hot folder registration/edit screen 410 in hot folder registration mode. Meanwhile, pressing the hot folder edit button 405 with a hot folder displayed in the hot folder list 402 being selected displays the hot folder registration/edit screen 410 in hot folder edit mode.

The hot folder registration/edit screen 410 has a hot folder naming section 411 and flexible setting sections 412, 414, and 416. The hot folder registration/edit screen 410 has a copy count setting section 413, a base material width setting section 415, an output profile setting section 417, a confirm button 418, and a cancel button 419. In a case where the hot folder registration/edit screen 410 is displayed in hot folder registration mode, the setting items 411 to 417 are displayed blank. In a case where the hot folder registration/edit screen 410 is displayed in hot folder edit mode, the setting items 411 to 417 are displayed with current settings. The flexible setting sections 412, 414, and 416 are each used to select whether the corresponding setting item is set as an item whose set value is rewritten using a print job ticket. The flexible setting section 412, the flexible setting section 414, and the flexible setting section 416 correspond to the copy count setting section 413, the base material width setting section 415, and the output profile setting section 417, respectively. In a state where the flexible setting section 412, 414, or 416 is selected, a corresponding one of the copy count setting section 413, the base material width setting section 415, and the output profile setting section 417 is deactivated so as not to accept any setting input. Once the cancel button 419 is pressed, settings registered or edited on this screen do not take effect, and the screen returns to the hot folder setting screen 401.

In a case where the hot folder registration/edit screen 410 is displayed in hot folder edit mode, upon pressing of the confirm button 418, hot folder setting information retained by the setting component 301 is updated to the set values set on this screen. Also, in a case where the hot folder registration/edit screen 410 is displayed in hot folder registration mode, upon pressing of the confirm button 418, a new hot folder named as inputted on the hot folder naming section 411 is created. Then, the hot folder setting information set on this screen is registered in the setting component 301.

Referring back to FIG. 3, a created hot folder is configured on a file system 310. A hot folder created with any of the flexible setting sections 412, 414, and 416 being selected is identified on the file system 310 as a flexible hot folder 311. Also, a hot folder created with none of the flexible setting sections 412, 414, and 416 being selected is identified on the file system 310 as a fixed hot folder 312. In other words, the fixed hot folder 312 may be called a hot folder with fixed set values, in which particular set values are set for the setting items. Note that a hot folder is prepared for each set of print settings, and a different hot folder is created in a case where even a single item has a different print setting. Thus, in one example, there may be hundreds of hot folders.

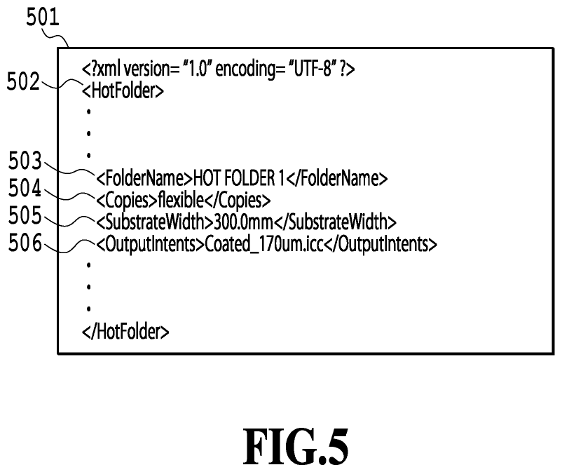

Also, once a hot folder is created or a setting of a hot folder is updated, the setting component 301 outputs a hot folder setting information file 501 like the one shown in FIG. 5. FIG. 5 is a diagram showing an example of a hot folder setting information file in XML format. The hot folder setting information file is described with reference to FIG. 5. The hot folder setting information file 501 has a hot-folder-related element 502. The hot-folder-related element 502 includes an element 503 related to a hot folder name, an element 504 related to a copy count setting, an element 505 related to a base material width setting, and an element 506 related to an output profile setting. Set values set on the hot folder registration/edit screen 410 in FIG. 4 are described in the elements 503 to 506. As shown in FIG. 5, in a case where the flexible setting section 412 in FIG. 4 is selected, “flexible” is described in the element 504 related to a copy count setting, indicating that the copy count setting is changeable. This applies not only to the element 504 related to a copy count setting, and in a case where the flexible setting is selected for a certain setting, “flexible” is described in the element corresponding to the selected setting.

Referring back to FIG. 3, the folder sharing component 302 performs setting for sharing a hot folder created or edited by the setting component 301 and performs setting for un-sharing a hot folder deleted by the setting component 301. Although Server Message Block (SMB) is used in the example described in the present embodiment as a hot-folder sharing protocol, the present disclosure is not limited to this. For example, File Transfer Protocol (FTP), Secure Shell (SSH), Secure File Transfer Protocol (SFTP), or the like may be used as the hot-folder sharing protocol. Once the setting component 301 creates or update a hot folder, the folder sharing component 302 starts network file sharing of the folder using the SMB protocol. Once the hot folder sharing is started, a file access to this hot folder is allowed by use of the SMB protocol on the host computer 101. Also, once the setting component 301 deletes a hot folder, the folder sharing component 302 cancels network file sharing of the folder using the SMB protocol. Once the hot folder is un-shared, a file access to this hot folder is not allowed on the host computer 101.

The folder monitoring component 303 monitors hot folders and detects print job files and, as needed, print job tickets. The folder monitoring component 303 detects that a print job file is saved in the flexible hot folder 311 or the fixed hot folder 312. Then, the folder monitoring component 303 notifies the job managing component 304 of the hot folder as well as the print job file and, as needed, a print job ticket and issues a print request. In response to a print request from the folder monitoring component 303, the job managing component 304 performs processing to have the print engine 214 print the print job file in the hot folder notified. In this processing for having the print engine 214 perform printing, the job managing component 304 refers to the hot folder setting information on the hot folder in which the print job file is stored, so that image data set in the print job file may be outputted according to the print settings in the setting information.

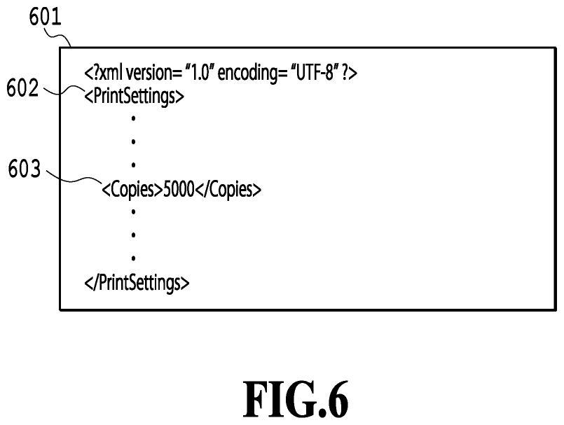

In a case where the hot folder notified is a fixed hot folder, the job managing component 304 performs the processing for having the print engine 214 perform printing so that image data set in the print job file may be outputted according to the print settings in the hot folder setting information. Meanwhile, in a case where the hot folder notified is a flexible hot folder, the job managing component 304 changes the setting item with a “flexible” setting in the print settings in the hot folder setting information to the setting in the print job ticket notified. Although a print job ticket in XML format shown in FIG. 6 is described as an example in the present embodiment, the present disclosure is not limited to this. FIG. 6 is a diagram showing an example of a print job ticket. A print job ticket in XML format is described with reference to FIG. 6. A print job ticket 601 has a print setting element 602. What is described in the print setting element 602 is a setting element corresponding to a setting item with a “flexible” setting and selected on the hot folder registration/edit screen 410 in FIG. 4. For example, as shown in FIG. 6, in a case where the flexible setting section 412 is selected, the print setting element 602 includes a copy count setting element 603. The copy count setting element 603 has a description stating that a print copy count is set to 5000 copies. Referring back to FIG. 3, the job managing component 304 changes the print settings in the hot folder setting information to the print setting in the print job ticket and has the print engine 214 perform printing so that image data set in the print job file may be outputted. Also, upon detection of completion of the print processing by the print engine 214, the job managing component 304 deletes the print job file and the print job ticket in the hot folder for which the printing processing has been completed.

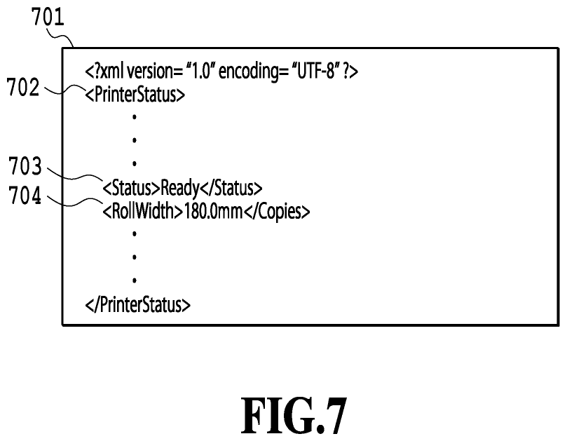

The printer status monitoring component 305 monitors the printing apparatus 201. The printer status monitoring component 305 writes a printer information file 701, like the one shown in FIG. 7, into a printer information folder 313 configured on the file system 310. Although the printer information file is in XML format in the example described in the present embodiment, the present disclosure is not limited to this. FIG. 7 is a diagram showing an example of the printer information file. A printer information file in XML format is described with reference to FIG. 7. The printer information file 701 has a printing apparatus status element 702. What is described in the printing apparatus status element 702 is an element indicating the current status of the printing apparatus 201. Specifically, the printing apparatus status element 702 includes a Status element 703 indicating the current printability status of the printing apparatus 201 and a RollWidth element 704 indicating the width of the roll paper currently loaded in the printing apparatus 201. In the printing apparatus status element 702, a character string “Ready” is described in a case where the printing apparatus 201 is ready to print, and a character string “Error” is described in a case of error status. In FIG. 7, a numerical value and a unit indicating that roll paper measuring 180.0 mm in width is being loaded are described in the RollWidth element 704. Note that in a case where roll paper loaded in the printing apparatus 201 is changed and a setting of the roll paper width is updated, a numeral value and a unit indicating the new roll paper width are described in the Roll Width element 704.

### <Configuration of the Label Print Application>

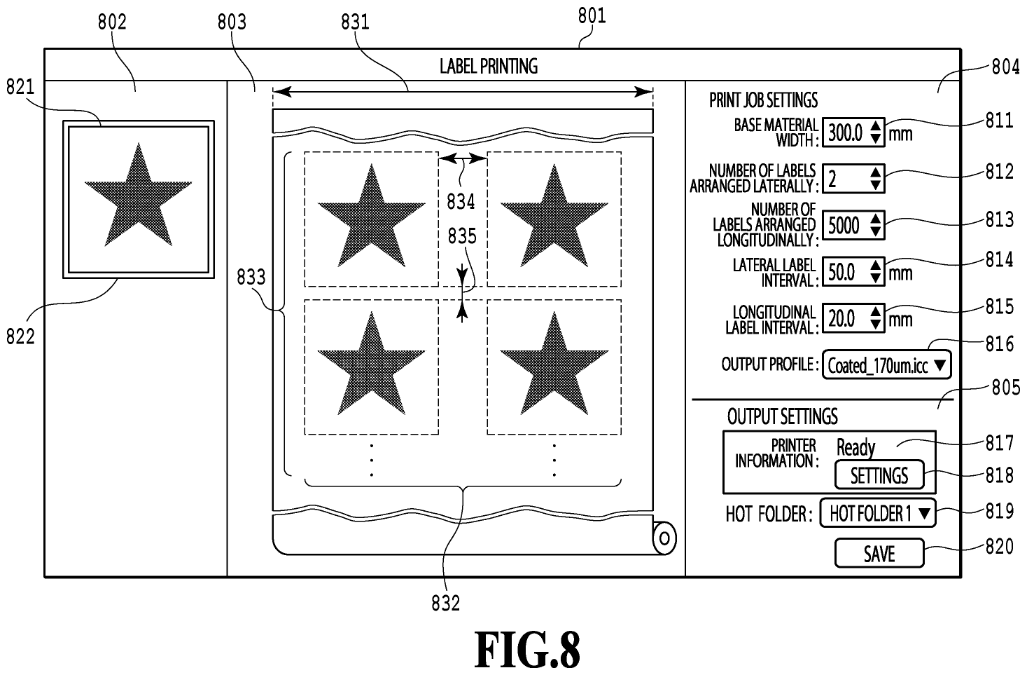

FIG. 8 is a diagram showing an example of a screen of the label print application that runs on the host computer 101. Print job setting and a print job file are described with reference to FIG. 8. The label print application is an application that receives layout settings on read label data and outputs a print job file and, as needed, a print job ticket to a selected hot folder in order to print it with the printing apparatus 201. In a state where label data has been read, an application window 801 has a label selection section 802, a preview section 803, a print job setting section 804, and an output setting section 805.

The label selection section 802 is a region for selecting read label data to print. As shown in FIG. 8, in the label selection section 802, sets of label data are displayed as a list of thumbnails. In this example, label data with a thumbnail 821 is selected in a selection frame 822 and is a print target.

The preview section 803 is a region displaying the layout in which the selected label data will be printed based on the settings in the print job setting section 804. The print job setting section 804 is a region for receiving settings on a print job file configured through user operations. As shown in FIG. 8, the following settings are configured in the print job setting section 804. In the print job setting section 804, first, “300.0” is set as a base material width 811. A base material width indication 831 in the preview section 803 is an indication corresponding to the base material width 811. Next, “2” is set as a number of labels arranged laterally 812. The set value “2” of the number of labels arranged laterally 812 indicates that two sets of label data are arranged along the width of the base material. A number of labels arranged 832 in the preview section 803 is an indication corresponding to the number of labels arranged laterally 812. Note that a base material is a printing medium such as roll paper loaded in the printing apparatus 201.

In a number of labels arranged longitudinally 813, “5000” is set. The set value “5000” of the number of labels arranged longitudinally 813 indicates that 5000 sets of label data are arranged along the length of the base material. A number of labels arranged 833 in the preview section 803 is an indication corresponding to the number of labels arranged longitudinally 813. Sets of label data arranged in the direction of the length of the base material (base material length) may be indicated in any way as long as a user can visually see that a specified number of sets of label data are arranged in the base material length direction. A scroll bar or the like may be used for this indication. In the present embodiment, data in which a single label is disposed in the base material length direction is created as print data. Thus, the number of labels arranged longitudinally is set in a print job as a print copy count, so that a plurality of labels are consecutively printed in the base material length direction. Next, “50.0” is set as a lateral label interval 814. The set value “50.0” for the lateral label interval 814 indicates that adjacent sets of label data are arranged at intervals of 50.0 mm in the base material width direction. A lateral interval 834 in the preview section 803 is an indication corresponding to the lateral label interval 814.

In a longitudinal label interval 815, “20” is set. The set value “20” of the longitudinal label interval 815 indicates that adjacent sets of label data are arranged at intervals of 20.0 mm in the base material length direction. A longitudinal interval 835 in the preview section 803 is an indication corresponding to the longitudinal label interval 815. Print data created in the present embodiment is data in which a single label is disposed in the base material length direction. In this case, considering that a plurality of labels are printed consecutively based on the copy count setting, labels that are adjacent in the base material length direction are arranged at positions with the intervals of 20.0 mm on a printed result. Next, “Coated_170um.icc” is selected as an output profile 816. In the output profile 816, the output color of the labels is set. A reproduction of the output colors using a profile selected by color matching performed at the time of printing is displayed in the preview section 803 as soft-proofing.

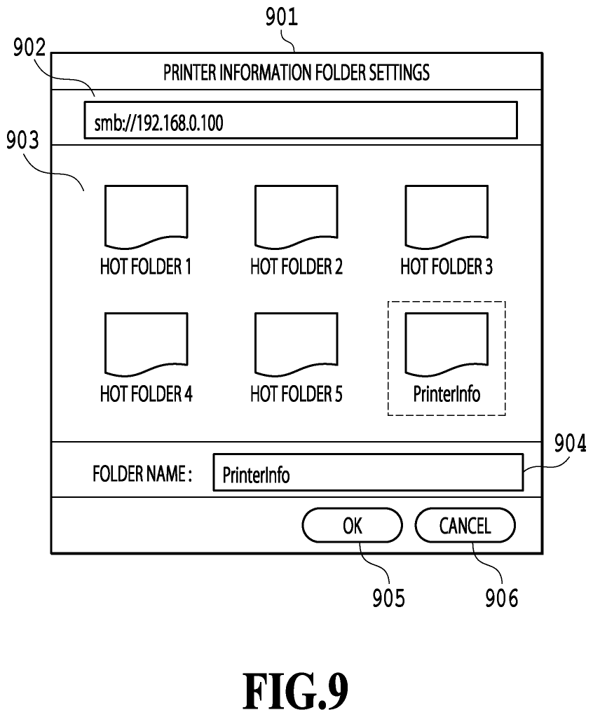

Next, settings are configured in the output setting section 805 through user operations in order to check the status of the printing apparatus 201 and save a print job file. First, once a printer information setting button 818 is pressed to obtain information indicating the status of the printing apparatus 201 which is to perform printing (hereinafter referred to as printer information), a printer information folder setting screen 901 is displayed as shown in FIG. 9. The printer information includes, as described earlier, information indicating the current printability of the printing apparatus 201 and information indicating the width of roll paper loaded in the printing apparatus 201. FIG. 9 is a diagram showing an example of the printer information folder setting screen. Setting of a printer information folder from which to obtain printer information on the printing apparatus 201 is described with reference to FIG. 9. The printer information folder setting screen 901 has a root folder display section 902, a folder display region 903, a folder name display section 904, a confirm button 905, and a cancel button 906. The root folder display section 902 is a region for displaying a root folder of the printing apparatus 201 with a URI. In the present embodiment, the host computer 101 shares the printer information folder 313 with the printing apparatus 201 using the SMB protocol. Also, as described earlier, once a hot folder is created or updated, the host computer 101 shares the hot folder with the printing apparatus 201 using the SMB protocol. For example, in a case where the IP address of the printing apparatus 201 connected to the network is “192.168.0.100,” a URI describing the protocol in a scheme format, “smb://192.168.0.100,” is displayed in the root folder display section 902. Specifically, in order for the host computer 101 to access a folder including the printer information folder 313 shared with the printing apparatus 201, a root folder in which the folder is saved is specified in the root folder display section 902 with a URI. In the folder display region 903, a list of accessible folders under the root folder, including the printer information folder 313, is displayed. Once a user selects a printer information folder from the folders displayed in the folder display region 903, the name of the selected printer information folder is displayed in the folder name display section 904. Then, upon pressing of the confirm button 905, the selected printer information folder is set as a folder from which to obtain printer information. After that, the printer information folder setting screen 901 is closed, and display processing is performed to go back to the application window 801. Meanwhile, upon pressing of the cancel button 906, the printer information folder is not set. After that, screen display processing is performed similarly to the case where the confirm button 905 is pressed.

Referring back to FIG. 8, once the printer information folder is set, the label print application reads the printer information file 701 stored in the printer information folder, at certain time intervals. Then, the label print application displays, in a printing apparatus status 817, the value of the Status element 703 indicating the current printability of the printing apparatus 201. Note that in a case where a printer information folder is not set, the value of the Status element 703 cannot be obtained by the label printing application and therefore is not displayed in the printing apparatus status 817.

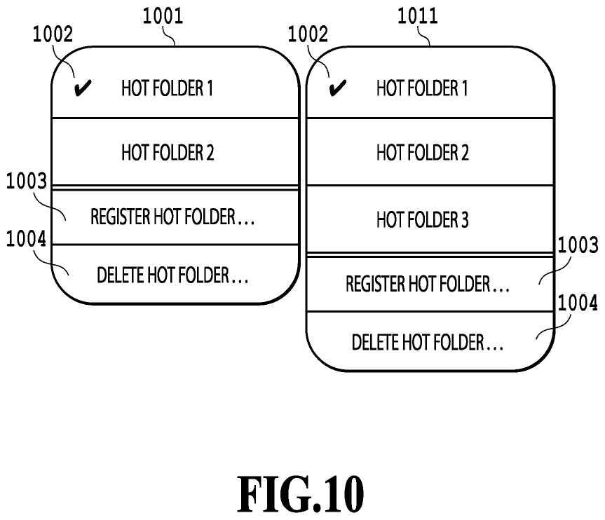

A hot folder selection section 819 is a selection region for selecting a hot folder in which to save the print data. Once a user presses the hot folder selection section 819, pre-registered hot folders shared with the printing apparatus 201 are displayed as a menu list. Specifically, as shown in FIG. 10, a hot folder menu list 1001 is displayed. FIG. 10 is a diagram showing an example of the hot folder menu list. A list presentation of hot folders is described with reference to FIG. 10. The hot folder menu list 1001 has a hot folder list registration menu 1003 and a hot folder list deletion menu 1004. Also, in a case where hot folders ae registered in advance, a list of registered hot folders is displayed in the hot folder menu list 1001. Note that although an example where there are two registered hot folders is described as shown in FIG. 10, the present disclosure is not limited to this. For example, an enormous number of hot folders may be registered like in actual usage. Once a user selects a hot folder in the hot folder menu list 1001, a selection mark 1002 indicating that the hot folder is selected is displayed. Specifically, in a case where the user selects a hot folder 1, the selection mark 1002 is displayed for the hot folder 1 in the list, as shown in FIG. 10. Note that the list presentation may be in text as shown in FIG. 10 or in folder icons. Also, although the list is displayed in a single row here as an example, hot folders may be displayed in a different format, such as, for example, a table format having a plurality of rows and a plurality of columns.

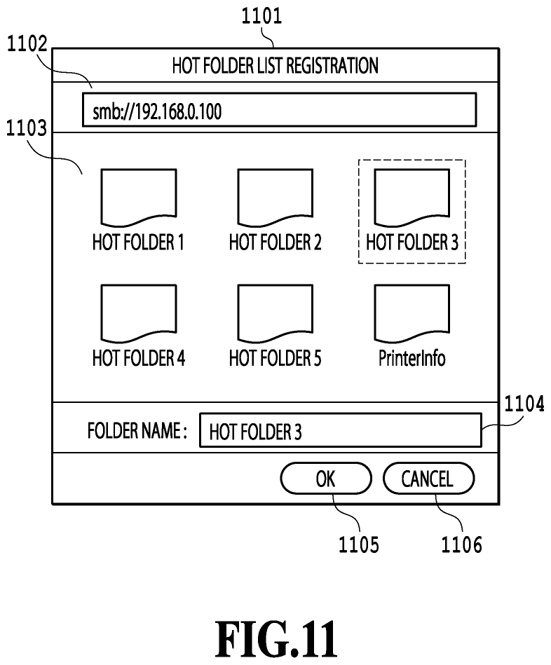

The hot folder list registration menu 1003 is a menu for registering a hot folder. Upon pressing of the hot folder list registration menu 1003, a hot folder list registration screen 1101 is displayed as shown in FIG. 11. FIG. 11 is a diagram showing an example of the hot folder list registration screen. The hot folder list registration screen 1101 has a root folder display section 1102, a folder display region 1103, a folder name display section 1104, a confirm button 1105, and a cancel button 1106. In the present embodiment, the host computer 101 shares the flexible hot folder 311 and the fixed hot folder 312 of the printing apparatus 201 using the SMB protocol. For example, in a case where the IP address of the printing apparatus 201 connected to the network is “192.168.0.100,” a URI describing the protocol in a scheme format, “smb://192.168.0.100,” is displayed in the root folder display section 1102. Specifically, in order for the host computer 101 to access a folder including the printer information folder 313 shared with the printing apparatus 201, a root folder in which the folder is saved is specified in the root folder display section 1102 with a URI. In the folder display region 1103, a list of accessible folders including folders under the root folder, is displayed. Once a user selects a hot folder to register from the folders displayed in the folder display region 1103, the name of the selected hot folder is displayed in the folder name display section 1104. Upon pressing of the confirm button 1105, the selected hot folder is registered in the hot folder menu list. For instance, in a case where the confirm button 1105 is pressed with a hot folder 3 being selected, after that, the hot folder list registration screen 1101 is closed, and processing is performed to display a hot folder menu list 1011 having the hot folder 3 added to the list. Also, upon pressing of the cancel button 1106, the selected hot folder is not registered on the hot folder menu list. After that, the hot folder list registration screen 1101 is closed, and processing is performed to go back to the hot folder menu list 1001.

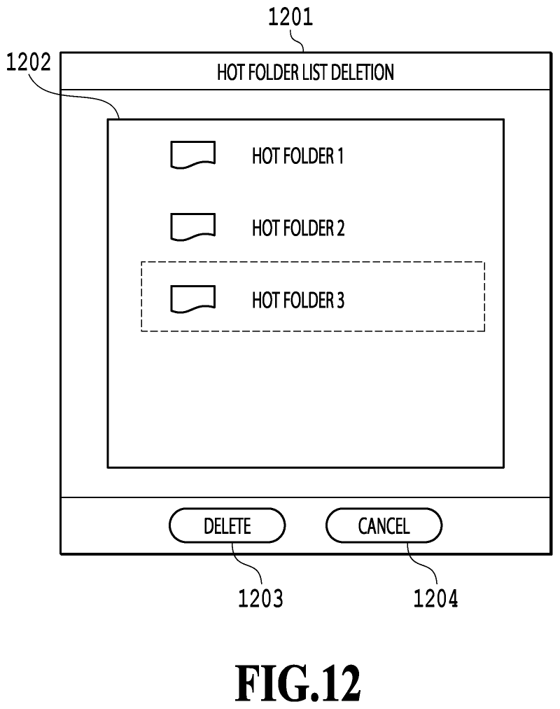

Referring back to FIG. 10, the hot folder list deletion menu 1004 is a menu for deleting a registered hot folder. Upon pressing of the hot folder list deletion menu 1004, a hot folder list deletion screen 1201 is displayed as shown in FIG. 12. FIG. 12 is a diagram showing an example of the hot folder list deletion screen. The hot folder list deletion screen 1201 has a hot folder list 1202, a deletion button 1203, and a cancel button 1204. The names of registered hot folders are displayed in the hot folder list 1202 in list form.

A user can delete a hot folder from the hot folder list 1202 by selecting the hot folder and pressing the deletion button 1203. For example, in a case where the deletion button 1203 is pressed with the hot folder 3 being selected, the hot folder list deletion screen 1201 is closed after that, and processing is performed to display the hot folder menu list 1001 without the hot folder 3. Also, in a case where the cancel button 1204 is pressed, the selected hot folder is not deleted from the list. After that, processing is performed to close the hot folder list deletion screen 1201 and go back to the hot folder menu list 1011.

Referring back to FIG. 8, a save button 820 is a button for saving a print job file and, as needed, a print job ticket. Once the save button 820 is pressed, the label printing application saves the print data including the setting information such as laid-out label data, in the selected hot folder as a print job file. Also, in a case where the selected hot folder is a flexible hot folder, the label printing application saves a print job ticket in the selected hot folder. Specifically, in a case where the hot folder selected in the hot folder selection section 819 is a fixed hot folder, a print job file is saved in the selected hot folder. Also, in a case where the hot folder selected in the hot folder selection section 819 is a flexible hot folder, a print job file and a print job ticket are saved in the selected hot folder.

### <Hot Folder List Update Processing>

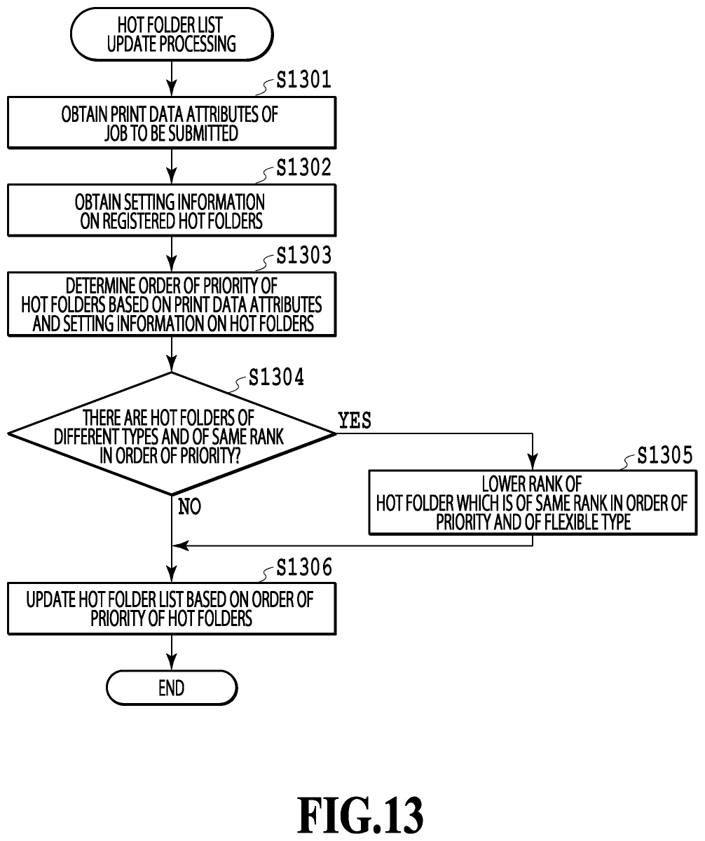

FIG. 13 is a flowchart showing an example of hot folder list update processing. Hot folder list update processing executed by the label printing application is described with reference to FIG. 13. The processing shown in FIG. 13 is implemented by the CPU 111 of the host computer 101 reading a program stored in the ROM 112 or the like into the RAM 113 and executing the program. Note that some or all of the steps in FIG. 13 may be implemented by hardware such as an ASIC or an electric circuit. The letter “S” used in descripting processing means that the processing is a step in the flowchart (this applies to all the flowcharts herein). Also, upon receipt of input of a set value to a setting item related to print settings in the print job setting section 804, the label printing application executes the hot folder list update processing shown in FIG. 13. For instance, the CPU 111 executes the hot folder list update processing once a set value is inputted or changed on the base material width 811, the number of labels arranged longitudinally 813, or the output profile 816, which are related to print settings.

In S1301, the CPU 111 obtains print data attributes (first print setting information) in a print job to be submitted to a hot folder. It is assumed here that, as the print data attributes, the CPU 111 obtains “300.0 mm” in the base material width 811, “5000” in the number of labels arranged longitudinally 813, and “Coated_170um.icc” in the output profile 816. After that, the CPU 111 proceeds to processing in S1302. Note that the base material width 811, the number of labels arranged longitudinally 813, and the output profile 816, which are print data attributes, correspond to the element related to the base material width setting, the element related to the copy count setting, and the element related to the output profile, respectively, in the hot folder setting information file.

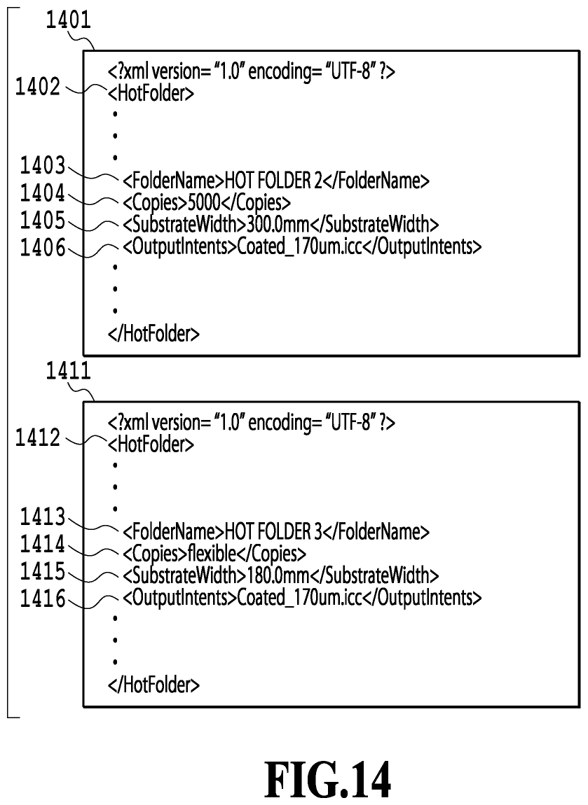

In S1302, the CPU 111 obtains setting information (second print setting information) on hot folders already registered on the list. For example, as shown in the hot folder menu list 1011, it is assumed that hot folders 1, 2, and 3 are registered on the list. In this case, the CPU 111 obtains 501 in FIG. 5, 1401 in FIGS. 14, and 1411 in FIG. 14 as the hot folder setting information files of the respective hot folders. After that, the CPU 111 proceeds to processing in S1303. FIG. 14 is a diagram showing examples of the hot folder setting information file. The hot folder setting information files of the hot folder 2 and the hot folder 3 are described with reference to FIG. 14. The hot folder setting information file 1401 includes elements 1404 to 1406 set for the hot folder 2. The configuration of the hot folder setting information file 1401 is the same as that of the hot folder setting information file 501 and is therefore not described here. In the hot folder setting information file 1401, a value “5000” is described in the element 1404 related to the copy count setting. By contrast, in the hot folder setting information file 501, “flexible” is described in the element 504 related to the copy count setting. In other words, the hot folder 1 and the hot folder 2 have different settings as to the copy count for label printing. The hot folder setting information file 1411 includes elements 1414 to 1416 set for the hot folder 3. In the hot folder setting information file 1411, a value “180.0 mm” is described in the element 1415 related to the base material width setting. By contrast, in the hot folder setting information file 501, “300.0 mm” is described in the element 505 related to the base material width setting. In other words, the hot folder 1 and the hot folder 3 have different settings as to the base material width.

In S1303, the CPU 111 determines the order of priority of the hot folders based on the printing data attributes obtained in S1301 and the setting information on the hot folders obtained in S1302. In the present embodiment, the order of priority is determined after assignment of weights to the setting items to be prioritized. Here, the weights are 2.0 for the copy count setting, 1.5 for the base material setting, and 1.0 for the output profile setting.

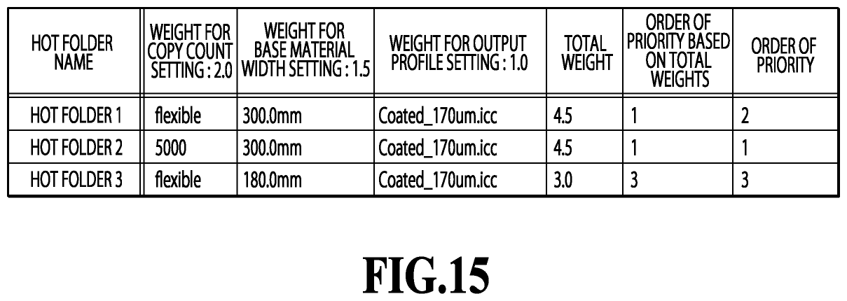

FIG. 15 is a diagram showing an example of a hot folder priority order table. How the label printing application determines the order of priority of hot folders is described with reference to FIG. 15. First, regarding the hot folder 1, the set values of the base material width and the output profile match those of the print data attributes. For a setting with a matching set value, a numerical value by which the setting is weighted is added. Meanwhile, the number of labels arranged longitudinally 813 in the print data attributes is “5000,” whereas the corresponding copy count setting in the hot folder 1 is “flexible.” In this case, because printing can be performed by outputting a print job ticket to the hot folder for which “flexible” is set, the weight of this setting item, i.e., 2.0, is further added. Thus, as shown in FIG. 15, the total weight on the hot folder 1 is 4.5. In this way, the print data attributes and the hot folder setting information are compared to each other, and in a case where the corresponding setting values match, the weight for the corresponding setting is added. Also, even in a case where the corresponding set values do not match, the weight for the corresponding setting is added as long as the setting in the hot folder is “flexible.” Next, as a result of performing calculation similarly to the above, the total weight on the hot folder 2 is 4.5. Regarding the hot folder 3, the base material width 811 of the print data attributes is “300.0 mm,” whereas the base material width of the hot folder 3 corresponding to this is 180.0 mm. In this case, the corresponding set values do not match, and therefore the weight for the corresponding setting is not added. Also, as a result of performing calculation on the other setting items similarly to the above, the total weight on the hot folder 3 is 3.0. The CPU 111 determines the order of priority as follows based on these total weights: the hot folder 1 and the hot folder 2 are ranked first in the order of priority and the hot folder 3 is ranked third in the order of priority. After that, the CPU 111 proceeds to processing in S1304.

Referring back to FIG. 13, in S1304, the CPU 111 determines, in the priority order table determined in S1303, whether there are hot folders which are of different types and are ranked the same in the order of priority. If determining that there are hot folders which are of different types and are ranked the same in the order of priority (YES), the CPU 111 proceeds to processing in S1305, and if not (NO), the CPU 111 proceeds to processing in S1306. For instance, regarding the hot folders shown in FIG. 15, the CPU 111 determines in S1303 that the hot folders 1 and 2 are ranked the same in the order of priority. Also, the CPU 111 determines the types of the hot folders 1 and 2 based on whether “flexible” is set for any of the setting items of the hot folders. Specifically, the CPU 111 determines that the hot folder 1 is a flexible hot folder because “flexible” is set for the copy count setting thereof. Also, the CPU 111 determines that the hot folder 2 is a fixed hot folder because “flexible” is set for none of the setting items thereof. In other words, in this case, the CPU 111 determines that there are hot folders which are of different types and are ranked the same in the order of priority.

In S1305, on the hot folders determined in S1303 as being ranked the same in the order of priority in the priority order table, the CPU 111 performs processing to lower the rank of the flexible hot folder in the order of priority. In this case, the CPU 111 changes the rank of the flexible hot folder 1 from first to second. Thus, the order of priority of the hot folders determined by the CPU 111 after the processing in S1305 is such that the hot folder 2 is ranked first in the order of priority, the hot folder 1 is ranked second in the order of priority, and the hot folder 3 is ranked third in the order of priority. The reason for this processing is because a flexible hot folder requires generation and interpretation of a print job ticket and therefore requires more processing cost than a fixed hot folder. Thus, from the perspective of improving the overall throughput of the printing system, a fixed hot folder is prioritized. After that, the CPU 111 proceeds to processing in S1306.

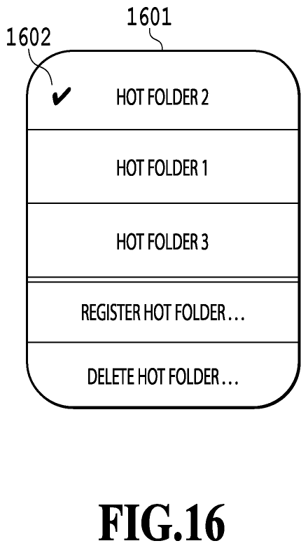

In S1306, the CPU 111 updates the hot folder list based on the determined order of priority of the hot folders, and the present processing ends. After that, once a user presses the hot folder selection section 819, the CPU 111 displays an updated hot folder menu list 1601 as shown in FIG. 16. FIG. 16 is a diagram showing an example of the updated hot folder menu list. Based on the hot folder priority order determined in S1305, the registered hot folders are displayed in list form. Specifically, a list of host folders is displayed, with the ones of higher ranks in the order of priority being presented at higher positions in the list. Also, the hot folder 2, which is ranked highest in the order of priority, is the currently-selected hot folder, and a selection mark 1602 is displayed next to the hot folder 2. Note that although the “hot folder 1” is displayed in the hot folder selection section 819 of the application window 801 in the present embodiment, the present disclosure is not limited to this. For example, after the hot folder list update processing, the “hot folder 2” ranked highest in the order of priority may be selected and displayed in the hot folder selection section 819.

In the example described in the present embodiment, the hot folder list update processing is executed once the label printing application receives input of a setting value to a setting item related to the print settings in the print job setting section 804. However, the present disclosure is not limited to this. For example, the CPU 111 may execute the present update processing upon registration or deletion of a hot folder on the list. In this case, once the hot folder list registration screen 1101 or the hot folder list deletion screen 1201 is closed after receiving the registration or deletion, the hot folder list is updated so that the registration or deletion takes effect. After that, the hot folder menu list where the registration or deletion takes effect is displayed, allowing a user to efficiently select a hot folder suitable for printing from the hot folders displayed.

As thus described, in the present embodiment, the label printing application determines the order of priority of hot folders based on the print data attributes in the print job and hot folder settings on the registered hot folders and displays a list of hot folders based on the order of priority. Thus, even in an environment where a large number of hot folders are registered, a hot folder for printing an image set in print data can be easily selected, which prevents erroneous printing.

### Second Embodiment

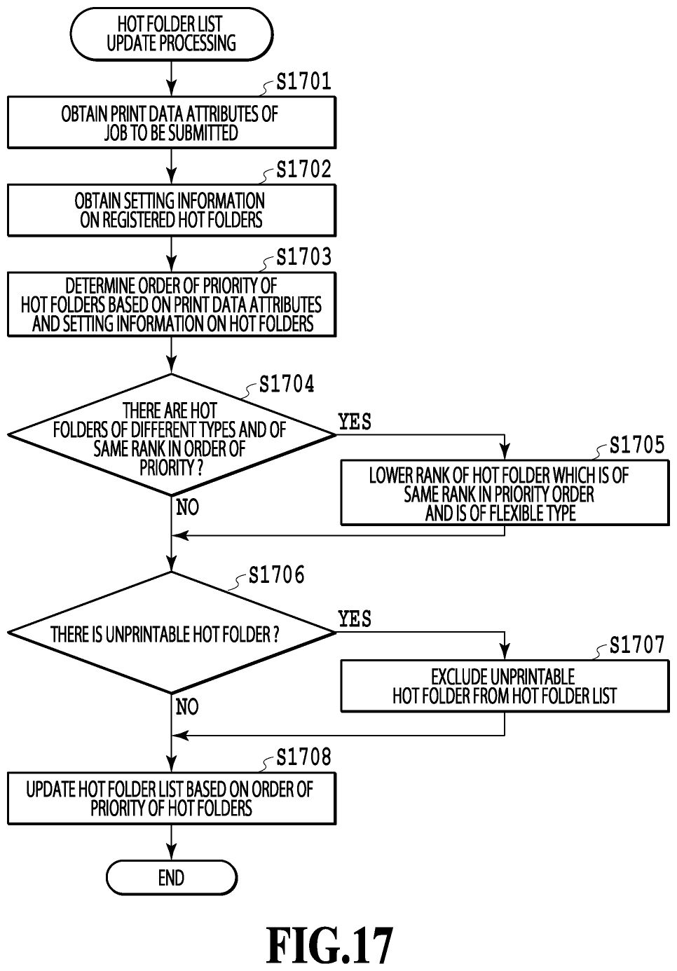

FIG. 17 is a flowchart showing an example of hot folder list update processing in a second embodiment. Hot folder list update processing of the present embodiment is described with reference to FIG. 17. Note that because the present embodiment has the same basic configuration as the first embodiment, the following describes configurations characteristic to the present embodiment. In the present embodiment, like in the first embodiment, the label printing application executes the hot folder list update processing shown in FIG. 17 upon receipt of input of a set value to a setting item related to print settings in the print job setting section 804.

In S1701, the CPU 111 obtains print data attributes of a print job to be submitted to a hot folder. Like in the first embodiment, it is assumed in the present embodiment that, as the print data attributes, the CPU 111 obtains “300.0 mm” in the base material width 811, “5000” in the number of labels arranged longitudinally 813, and “Coated_170um.icc” in the output profile 816. After that, the CPU 111 proceeds to processing in S1702.

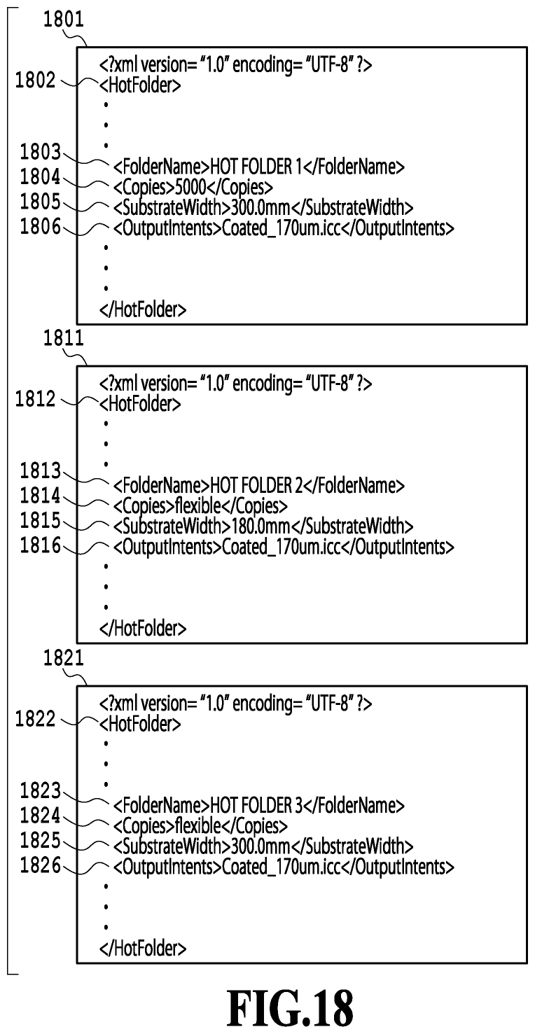

In S1702, the CPU 111 obtains setting information on hot folders registered on the list. It is assumed here that a hot folder 1, a hot folder 2, and a hot folder 3 are registered in the list. It is also assumed that as the hot folder setting information files for the hot folders, hot folder setting information files 1801, 1811, and 1821 shown in FIG. 18 are obtained. FIG. 18 is a diagram showing an example of hot folder setting information files. The configuration of the hot folder setting information files of the hot folders in FIG. 18 is the same as that of the hot folder setting information file 501 in FIG. 5 and is therefore not described here. A set numeral value or “flexible” is described in each element in each folder. In S1702, the CPU 111 obtains an element related to the copy count setting, an element related to the base material width setting, and an element related to the output profile in the hot folder setting information file for each of the hot folders in FIG. 18. After that, the CPU 111 proceeds to processing in S1703. In S1703, the CPU 111 determines the order of priority of the hot folders based on the print data attributes obtained in S1701 and the setting information on the hot folders obtained in S1702.

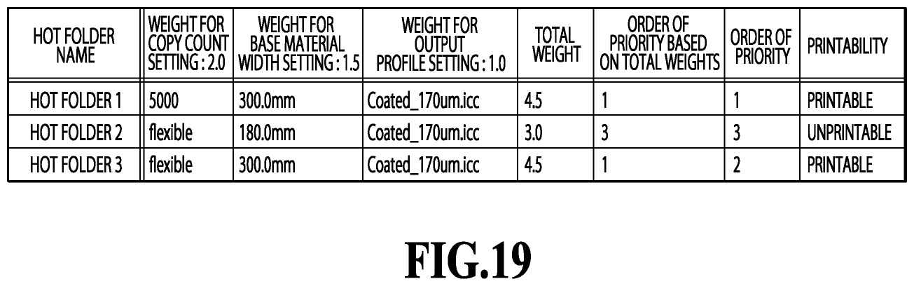

FIG. 19 is a diagram showing an example of a hot folder priority order table. How the label printing application determines the order of priority of hot folders is described with reference to FIG. 19. Note that a detailed method for calculating the total weights is as described earlier and is therefore not described here. First, as a result of comparison between print data attributes and setting information on the hot folder 1, the total weight for the hot folder 1 is calculated to be 4.5. Using the same calculating method, the total weight for the hot folder 2 is 3.0, and the total weight for the hot folder 3 is calculated to be 4.5. Based on these total weights, the CPU 111 determines that the order of priority is as follows: the hot folders 1 and 3 are ranked first in the order of priority, and the hot folder 2 is ranked third in the order of priority. After that, the CPU 111 proceeds to processing in S1704.

Processing in S1704 and processing in S1705 are the same as the processing in S1304 and the processing in S1305, respectively, and are therefore not described in detail here. Note that FIG. 19 shows the order of priority of the hot folders determined as a result of the processing in S1705. Specifically, the CPU 111 changes the rank of the flexible hot folder 3 in the order of priority from first to second. Then, as the order of priority of the hot folders after the processing in S1705, the CPU 111 determines that the hot folder 1 is ranked first in the order of priority, the hot folder 3 is ranked second in the order of priority, and the hot folder 2 is ranked third in the order of priority. After that, the CPU 111 proceeds to processing in S1706.

In S1706, the CPU 111 determines that the hot folders in the current priority order table include a hot folder with an unprintable setting. If determining that there is a hot folder with an unprintable setting (YES), the CPU 111 proceeds to processing in S1707, and if not (NO), the CPU proceeds to processing in S1708. For example, the base material width 811 obtained in S1701 as a print data attribute of the print job to be submitted to a hot folder is 300.0 mm, whereas the base material width setting of the hot folder 2 obtained in S1702 is 180.0 mm. Thus, because the base material width set in the print data is longer than the base material width setting of the hot folder 2, the CPU 111 determines that the print data is unprintable. Consequently, the CPU 111 determines that the hot folder 2 has an unprintable setting. In this case, the CPU 111 proceeds to processing in S1707. The CPU 111 also determines whether the hot folder 1 and the hot folder 3 have an unprintable setting. In this way, the CPU 111 makes a determination about printability for each of the hot folders registered in the list. FIG. 19 shows an example of determination made by the CPU 111 about printability regarding the hot folders 1 to 3. In FIG. 19, the “PRINTABILITY” item for the hot folders 1 and 3 says “PRINTABLE,” indicating that it is printable. Meanwhile, because the hot folder 2 has an unprintable setting as described earlier, the “PRINTABILITY” item for the hot folder 2 says “UNPRINTABLE” to indicate that the print data is unprintable. Referring back to FIG. 17, in S1707, the CPU 111 excludes a hot folder with an unprintable setting from the hot folders in the current priority order table. Specifically, in the case described with S1706, the CPU 111 excludes the hot folder 2 with an unprintable setting from the current priority order table. After that, the CPU 111 proceeds to processing in S1708.

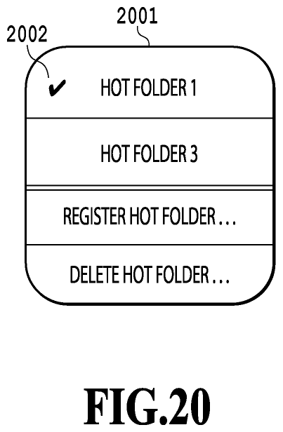

In S1708, the CPU 111 updates the hot folder list based on the hot folder priority order thus determined and ends the present processing. After that, once the user presses the hot folder selection section 819, the CPU 111 displays an updated hot folder menu list 2001 as shown in FIG. 20. FIG. 20 is a diagram showing an example of the updated hot folder menu list. As shown in FIG. 20, the registered hot folders are displayed in list form based on the hot folder priority order determined. Specifically, a list of hot folders is displayed, with the ones of higher ranks in the order of priority being displayed at higher positions in the list. The hot folder 2 excluded for having an unprintable setting is not displayed in the list. Also, the hot folder 1, which is ranked highest in the order of priority, is the currently-selected hot folder, and a selection mark 2002 is displayed next to the hot folder 1.

As thus described, in the present embodiment, the label printing application determines the order of priority of printable hot folders based on print data attributes in a print job and setting information on registered hot folders and displays a list of hot folders based on the order of priority. In the present embodiment, a hot folder with an unprintable setting is excluded from the list of hot folders, and hot folders with printable settings are displayed in list form in the order of suitability for the print data. Thus, even in an environment where a large number of hot folders are registered, a hot folder for printing an image set in print data can be easily selected, which prevents erroneous printing.

### Third Embodiment

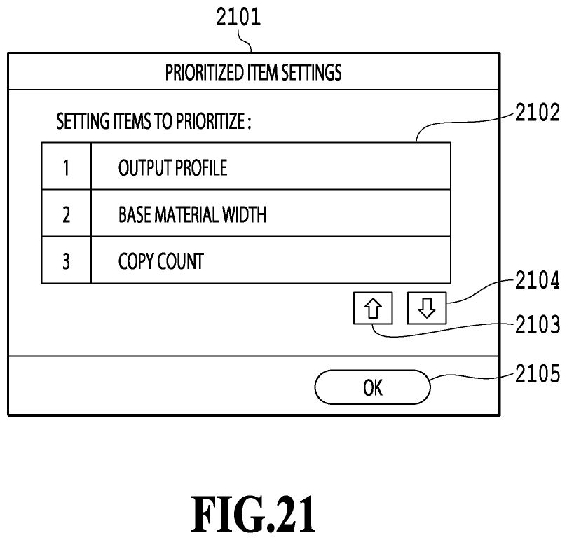

In the present embodiment, the label printing application previously receives a change to a setting item to be prioritized in determining the order of priority of hot folders. FIG. 21 is a diagram showing an example of a priority item setting screen 2101. Changing a setting item prioritized in determining the order of priority is described with reference to FIG. 21. A priority item setting screen 2101 has a list 2102 of setting items to prioritize, a switch-with-above button 2103, a switch-with-below button 2104, and a confirm button 2105. In the list 2102 of setting items to prioritize, setting items are displayed in order of priority. Specifically, FIG. 21 indicates that the level of priority is the highest for the output profile, the second highest for the base material width, and the third highest for the copy count. In this case, once the switch-with-above button 2103 is pressed with one of the setting items in the list being selected, the selected setting item is switched with the one above. Specifically, once the switch-with-above button 2103 is pressed with “base material width” being selected in the list 2102 of setting items to prioritize, “base material width” is switched with “output file,” which has a higher level of priority than “base material width.” Also, once the switch-with-below button 2104 is pressed with one of the setting items in the list being selected, the selected setting item is switched with the item below. Specifically, once the switch-with-below button 2104 is pressed with “base material width” being selected in the list 2102 of setting items to prioritize, “base material width” is switched with “copy count,” which has a lower priority level than “base material width.” Once the confirm button 2105 is pressed, the label printing application confirms the weights for the setting items used in determining the order of priority to be described later, based on the priority levels of the setting items thus changed. It is assumed in the following description that the setting items to prioritize are “output profile,” “base material width,” and “copy count” in this order.

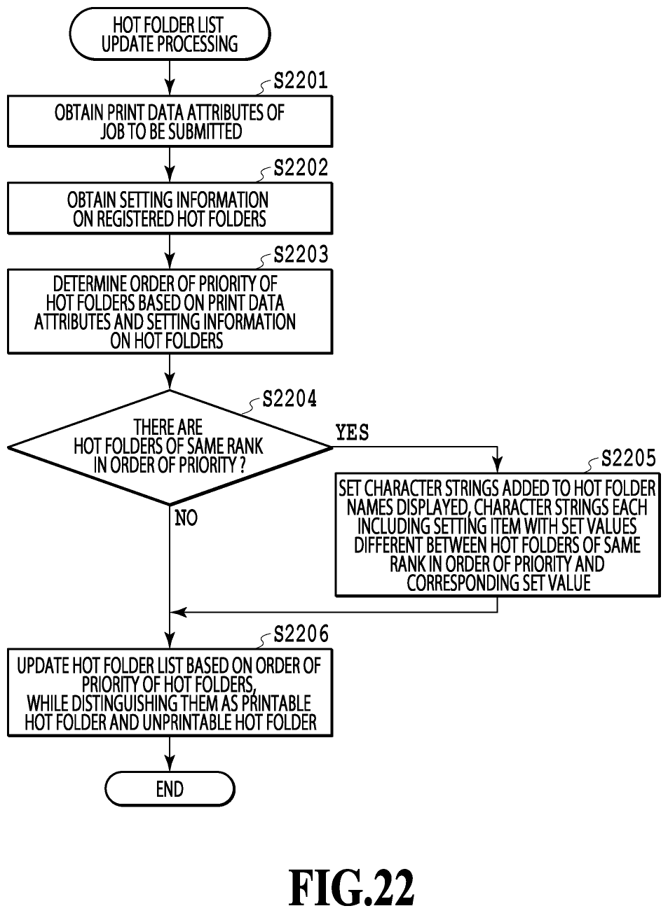

FIG. 22 is a flowchart showing an example of hot folder list update processing according to the third embodiment. Hot folder list update processing of the present embodiment is described with reference to FIG. 22. Note that because the present embodiment has the same basic configuration as those of the first and second embodiments, the following describes configuration characteristic to the present embodiment. The label printing application executes the hot folder list update processing shown in FIG. 22 upon receipt of input of a setting value to a setting item related to print settings in the print job setting section 804.

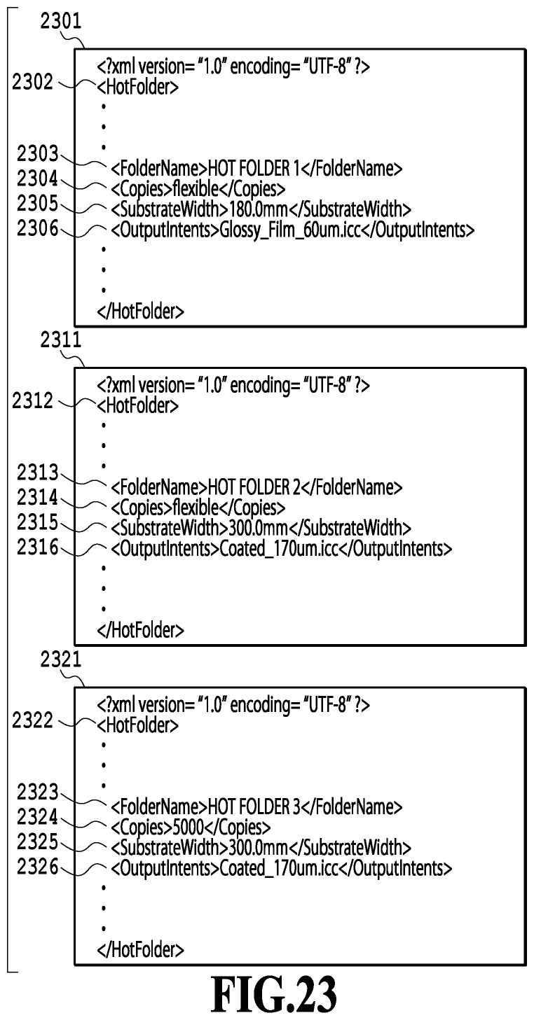

In S2201, the CPU 111 obtains print data attributes in the print job to be submitted to a hot folder. Like in the first embodiment and the like, it is assumed in the present embodiment that, as the print data attributes, the CPU 111 obtains “300.0 mm” in the base material width 811, “5000” in the number of labels arranged longitudinally 813, and “Coated 170um.icc” in the output profile 816. After that, the CPU 111 proceeds to processing in S2202. In S2202, the CPU 111 obtains setting information on the registered hot folders. It is assumed here that a hot folder 1, a hot folder 2, and a hot folder 3 are registered in the list. It is also assumed that as the hot folder setting information files of the hot folders, hot folder setting information files 2301, 2311, and 2321 shown in FIG. 23 are obtained. FIG. 23 is a diagram showing an example of hot folder setting information files. The configuration of the hot folder setting information files 2301, 2311, and 2321 is the same as that of the hot folder setting information file 501 in FIG. 5 and is therefore not described here. A set numeral value or “flexible” is described in each element in each folder in FIG. 23. In S2202, the CPU 111 obtains an element related to the copy count setting, an element related to the base material width setting, and an element related to the output profile of each of the hot folders in FIG. 23. After that, the CPU 111 proceeds to processing in S2203. In S2203, the CPU 111 determines the order of priority of the hot folders based on the print data attributes obtained in S2201 and the setting information on the hot folders obtained in S2202.

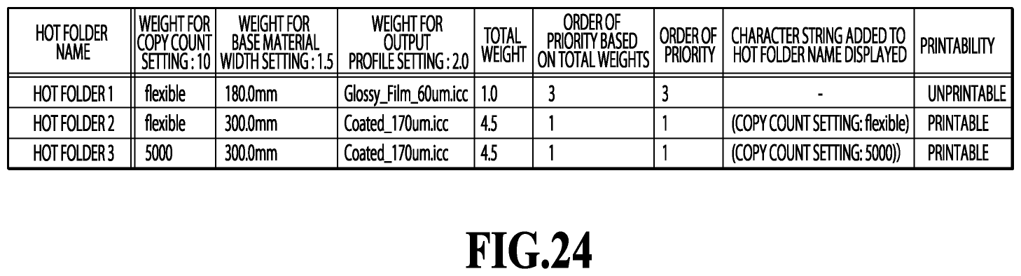

FIG. 24 is a diagram showing an example of a hot folder priority order table. How the label printing application determines the order of priority of hot folders is described with reference to FIG. 24. Note that a detailed method for calculating the total weights is as described earlier and is therefore not described here. First, as a result of comparison between print data attributes and setting information on the hot folder 1, the total weight for the hot folder 1 is calculated to be 1.0. Using the same calculating method, the total weight for the hot folder 2 is 4.5, and the total weight for the hot folder 3 is calculated to be 4.5. Based on these weight totals, the CPU 111 determines that the order of priority is as follows: the hot folders 2 and 3 are ranked first in the order of priority, and the hot folder 1 is ranked third in the order of priority. After that, the CPU 111 proceeds to processing in S2204.

In S2204, the CPU 111 determines whether the hot folders in the priority order table determined in S2203 include hot folders ranked the same in the order of priority. If determining that there are hot folders ranked the same in the order of priority (YES), the CPU 111 proceeds to processing in S2205, and if not (NO), the CPU 111 proceeds to processing in S2206. For example, regarding the hot folders shown in FIG. 24, the CPU 111 determines in S2203 that the hot folders 2 and 3 are ranked the same in the order of priority. Thus, in this case, the CPU 111 determines that there are hot folders ranked the same in the order of priority. In S2205, for the hot folders ranked the same in the order of priority in the priority order table determined in S2203, the CPU 111 performs processing to set character strings to be displayed in addition to the names of those hot folders, the character strings each including a setting item with different set values and a corresponding set value. For example, in FIG. 24, the hot folders 2 and 3 are hot folders ranked the same in the order of priority. Also, the set value of the copy count setting is “flexible” for the hot folder 2 and is “5000” for the hot folder 3. Thus, the CPU 111 determines that the hot folders ranked the same in the order of priority in the priority order table determined in S2203 have a setting item with set values different from each other. Then, for each of the hot folders 2 and 3, the CPU 111 sets character strings to be displayed in addition to the names of those hot folders in the hot folder menu list, the character strings each including the setting item with the different set values and the corresponding set value. In this case, the character string to be additionally displayed is “(copy count setting: flexible)” for the hot folder 2 and is “(copy count setting: 5000)” for the hot folder 3. After that, the CPU 111 proceeds to processing in S2206.

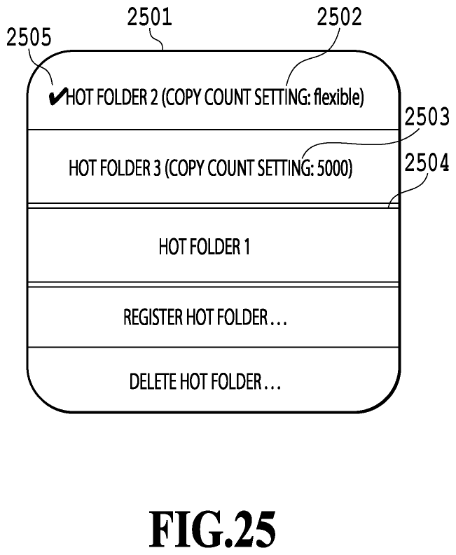

In S2206, based on the hot folder priority order determined, the CPU 111 identifies, in the hot folder list, a hot folder with a printable setting and a hot folder with an unprintable setting. Then, the CPU 111 updates the hot folder list and ends the present processing. After that, once the user presses the hot folder selection section 819, the CPU 111 displays the updated hot folder menu list as shown in FIG. 25. FIG. 25 is a diagram showing an example of an updated hot folder menu list screen 2501. First, based on the order of priority of the hot folders, the CPU 111 displays the hot folder 2 and the hot folder 3 in this order in list form as hot folders with printable settings. Specifically, an additionally displayed character string 2502 is displayed on the right side of the name of the hot folder 2 displayed, and an additionally displayed character string 2503 is displayed on the right side of the name of the hot folder 3 displayed. Also, in order to identify a hot folder with a printable setting and a hot folder with an unprintable setting, the CPU 111 determines the printability of each hot folder, as executed in the processing in S1706. As shown in FIG. 24, it is determined that the hot folder 1 has an unprintable setting and the hot folders 2 and 3 have printable settings. Then, in order for the user to recognize which hot folder has a printable setting and which hot folder has an unprintable setting, the CPU 111 displays a separator control 2504 as shown in FIG. 25. The CPU 111 displays the hot folder 1 with an unprintable setting separately from the hot folders 2 and 3 using the separator control 2504. The hot folder 2 displayed at the top of the list is the currently selected hot folder, and a selection mark 2505 is displayed next to the hot folder 2.

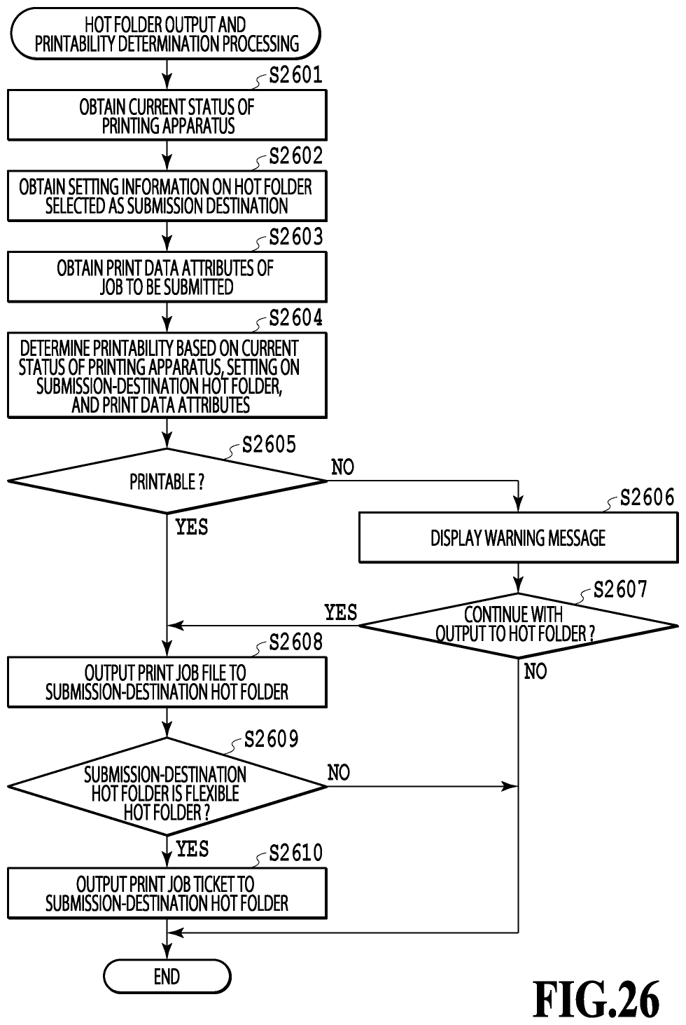

FIG. 26 is a flowchart showing an example of printability determination processing. Printability determination processing executed by the label printing application is described with reference to FIG. 26. The processing shown in FIG. 26 is implemented by the CPU 111 of the host computer 101 reading a program stored in the ROM 112 or the like into the RAM 113 and executing the program. The processing in FIG. 26 is started after the save button 820 is pressed. Note that in the following example, the save button 820 is pressed with the hot folder 2 with a printable setting being selected in the hot folder selection section 819.

In S2601, the CPU 111 obtains the current status of the printing apparatus 201. It is assumed here that the CPU 111 obtains, from the printer information file 701, a value indicating that the printing apparatus 201 is ready to print and a value indicating that roll paper measuring 180.0 mm in width is loaded. After that, the CPU 111 proceeds to processing in S2602. In S2602, the CPU 111 obtains setting information on the hot folder selected in the hot folder selection section 819 as a hot folder to which to submit a print job. It is assumed here that the CPU 111 obtains, from the hot folder setting information file 2311, “flexible” as a set value for the print copy count, “300.0 mm” as a set value for the base material width, and “Coated_170um.icc” as a set value for the output profile. After that, the CPU 111 proceeds to processing in S2603. In S2603, the CPU 111 obtains print data attributes in the print job to be submitted. It is assumed here that the CPU 111 obtains “300.0 mm” in the base material width 811, “5000” in the number of labels arranged longitudinally 813, and “Coated_170um.icc” in the output profile 816. After that, the CPU 111 proceeds to processing in S2604.

In S2604, the CPU 111 determines printability based on the current status of the printing apparatus 201 obtained in S2601, the setting information on the hot folder to which to submit the print job obtained in S2602, and the print data attributes of the print job to be submitted obtained in S2603. In this example, the base material width is set to 300.0 mm in the print data attributes of the print job to be submitted, and the base material width is set to 300.0 mm in the submission-destination hot folder, as well. Meanwhile, roll paper measuring 180.0 mm in width is loaded in the printing apparatus 201. Thus, because the current setting of the printing apparatus 201 is different from the obtained setting information on the hot folder to which to submit a print job and the obtained print data attributes of the print job to be submitted, the CPU 111 determines that there is a possibility that the print data cannot be printed. After that, the CPU 111 proceeds to processing in S2605. In S2605, the CPU 111 determines whether the print data can be printed. If determining that the print data is printable (YES), the CPU 111 proceeds to processing in S2608, and if not (NO), the CPU 111 proceeds to processing in S2606. Because the CPU 111 determines in S2604 that the print data is unprintable, in this case, the CPU 111 proceeds to processing in S2606.

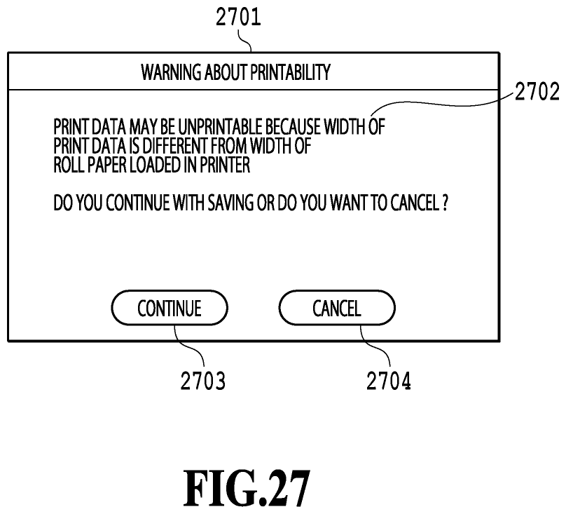

In S2606, the CPU 111 displays a warning message screen 2701 as shown in FIG. 27. FIG. 27 is a diagram showing an example of the warning message screen. A warning message displayed in a case where it is determined that the print data is unprintable is described with reference to FIG. 27. The warning message screen 2701 has a warning message 2702, a continue button 2703, and a cancel button 2704. The warning message 2702 is a message for warning the user about the setting value which has been determined in S2604 as being different. Specifically, the CPU 111 displays a message that there is a possibility that the print data cannot be printed because the width of the roll paper currently loaded in the printing apparatus 201 is different from the base material width set in the print data in the print job to be submitted. It goes without saying that the content of the warning message 2702 changes depending on the set value determined in S2604 as being different. After that, upon pressing of the continue button 2703 or the cancel button 2704 being pressed, the CPU 111 proceeds to processing in S2607. In this example, the user changes the roll paper in the printing apparatus from the roll paper measuring 180.0 mm in width to roll paper measuring 300.0 mm in width and then presses the continue button 2703 to proceed with saving of the print job.

Referring back to FIG. 26, in S2607, the CPU 111 determines whether the continue button 2703 or the cancel button 2704 is pressed on the warning message screen 2701. If the continue button 2703 is pressed, the CPU 111 proceeds to processing in S2608, and if the cancel button 2704 is pressed, the CPU 111 does not output the print job file to the hot folder and ends the present processing. Because the continue button 2703 is pressed on the warning message screen 2701 in this example, the CPU 111 proceeds to processing in S2608. In S2608, the CPU 111 outputs the print job file to the hot folder 2, which is the hot folder to which to submit the print job. After that, the CPU 111 proceeds to processing in S2609. In S2609, the CPU 111 determines whether the hot folder to which to submit the print job is a flexible folder. If determining that the hot folder is flexible (YES), the CPU 111 proceeds to processing in S2601, and if determining that the hot folder is a fixed hot folder (NO), the CPU 111 ends the present processing. Because the hot folder 2 as the submission-destination hot folder is a flexible hot folder in this example, the CPU 111 proceeds to processing in S2610. In S2610, the CPU 111 outputs the print job ticket to the hot folder 2, which is the hot folder to which to submit the print job, and ends the present processing. In this example, the CPU 111 outputs the print job ticket 601 in which “5000 copies” is set as the print copy count to the hot folder 2 and ends the present processing.

As thus described, in the present embodiment, a hot folder with an printable setting and a hot folder with an unprintable setting are distinguished, and they are displayed in list form so that the user can see the distinguishment. Thus, even in an environment where a large number of hot folders are registered, a hot folder for printing an image set in print data can be easily selected, which prevents erroneous printing. Also, in saving a printing job file, the label printing application obtains the current status of the printing apparatus and determines the printability based on the obtained status, the print data attributes of the print job, and the setting on the hot folder to which to submit print job. As a result of the determination, a warning is displayed in a case where the label printing application determines that there is a possibility that the print data cannot be printed. This allows erroneous printing to be prevented in advance in saving of a print job file.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-139884, filed Aug. 30, 2023, which is hereby incorporated by reference herein in its entirety.

What is claimed is:

1. An information processing method comprising:
obtaining
print data including first print setting information indicating setting information on printing and
second print setting information set for each of a plurality of hot folders and
displaying the plurality of hot folders based on the first print setting information and the second print setting information.

2. The information processing method according to claim 1, further comprising determining an order of priority of the plurality of hot folders based on the first print setting information and the second print setting information.

3. The information processing method according to claim 1, wherein
upon receipt of input of the first print setting information, the first print setting information is obtained.

4. The information processing method according to claim 1, wherein
on an application screen for receiving input of the first print setting information, the displaying is performed in response to a user pressing a selection region for selecting, from the plurality of hot folders, a hot folder to which to output the print data.

5. The information processing method according to claim 2, wherein
in a case where there are hot folders ranked same in the order of priority determined, the hot folder for which a particular set value is set is prioritized.

6. The information processing method according to claim 1, wherein
a hot folder with an unprintable setting is excluded from the plurality of hot folders displayed.

7. The information processing method according to claim 2, wherein
in a case where there are hot folders ranked same in the order of priority determined, for the hot folders ranked the same in the order of priority, a setting item with different setting values and the different set values are displayed.

8. The information processing method according to claim 2, wherein
based on the order of priority determined, a hot folder with a printable setting and a hot folder with an unprintable setting are displayed in a distinguishable manner.

9. The information processing method according to claim 1, wherein
once a printing apparatus to perform printing is selected and a hot folder is selected from the plurality of hot folders, printability of the print data is determined based on information indicating a status of the selected printing apparatus, the first print setting information, and the second print setting information set for the selected hot folder, and
a warning message is displayed in a case where it is determined that the print data is unprintable.

10. The information processing method according to claim 1, wherein
the plurality of hot folders are displayed with a hot folder ranked highest in an order of priority being selected.

11. The information processing method according to claim 1, wherein
the plurality of hot folders are displayed as a list.

12. An information processing apparatus comprising at least one memory and at least one processor which function as
an obtainment unit configured to obtain print data including first print setting information indicating setting information on printing and second print setting information set for each of a plurality of hot folders and
a display control unit configured to display the plurality of hot folders based on the first print setting information and the second print setting information.

13. A non-transitory computer readable storage medium storing a program for causing a computer to perform an information processing method comprising:
obtaining print data including first print setting information indicating setting information on printing and second print setting information set for each of a plurality of hot folders and
displaying the plurality of hot folders based on the first print setting information and the second print setting information.
